(19) United States
(12) Patent Application Publication
(10) Pub. No.: US 2003/0131087 A1
(43) Pub. Date: Jul. 10, 2003

(54) Method of using billing log activity to determine software update frequency

(76) Inventors: Keith L. Shippy, Tempe, AZ (US); Richard P. Mangold, Forest Grove, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/040,562

(22) Filed: Jan. 4, 2002

(51) Int. Cl. G06F 15/173

(52) U.S. Cl. 709/223

(57) ABSTRACT

Determining when to update software of a client device in a client/server architecture is accomplished by receiving client activity data from the client device, and updating software executed by the client device when the client activity data indicates activity less than a predetermined threshold for a selected period of time.

### BACKGROUND

1. Field

The present invention relates generally to software used by client/server architectures and, more specifically, to determining when to update software resident on client devices.

2. Description

Client/server architectures are widely used. In some client/server systems, client devices may be required to periodically report to the server the amount of activity being performed on the client devices. For example, when the client device is a satellite television or cable television set-top box, the client device may report client activity in receiving and viewing pay-per-view (PPV) programs back to the server so that the appropriate billing information may be compiled. If the owner of the client device is going to be charged for activity occurring on the client device, some owners may be motivated to make it appear as if the activity did not occur, in order to avoid the charges. Hence, “hacking” of the software operating on the client device may be attempted by the owner or possessor of the client device. In some systems, cryptography and tamper resistant technology may be employed to make it harder for a hacker to be successful in attempting such piracy. Although these methods may provide a deterrence to hacking, piracy may still occur. Consequently, additional forms of protection need to be implemented to increase the probability that the proper amount of client device activity is being reported back to the server.

### BRIEF DESCRIPTION OF THE DRAWINGS

The features and advantages of the present invention will become apparent from the following detailed description of the present invention in which:

FIG. 1 is a diagram of a system architecture according to an embodiment of the present invention;

FIG. 2 is a flow diagram illustrating using billing log activity to determine software update frequency according to an embodiment of the present invention; and

FIG. 3 is a diagram of an example system architecture using billing log activity to determine software update frequency according to an embodiment of the present invention.

### DETAILED DESCRIPTION

An embodiment of the present invention is a method of using client device activity reported in a billing log in determining when software operating on a client device is to be updated. When a client device communicates with a server, the client device may report the activity occurring on the client. For example, the amount and types of activity may be collected in a data structure called a billing log. If the amount of activity reportedly occurring on the client device falls below a predetermined threshold of activity over a predetermined period of time, it may be assumed that the client device software affecting the billing log for the client has been modified in an unauthorized manner. The server then downloads at least a portion of new software to the client device. In one embodiment, the new software includes new cryptographic keys for allowing access to content by the client device. In another embodiment, the new software downloaded to the client device re-configures the software resident on the client device to overcome the assumed hacking efforts.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

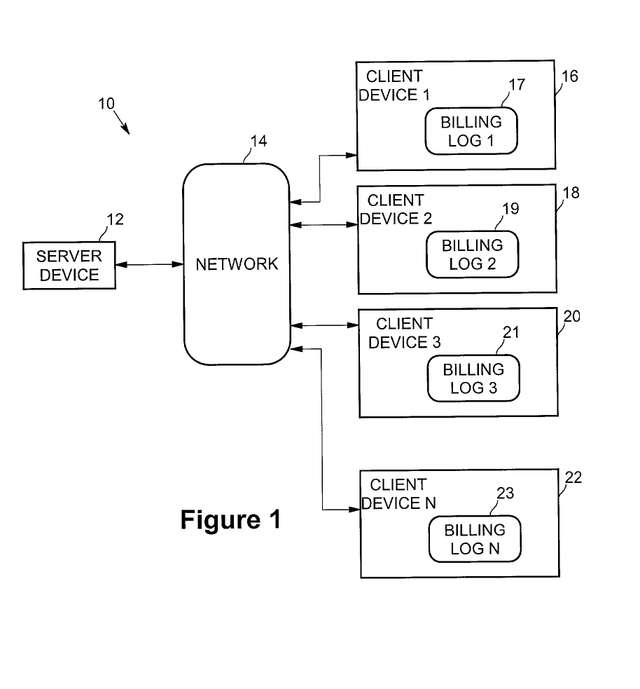

FIG. 1 is a diagram of a system architecture according to an embodiment of the present invention. This architecture 10 is representative of various well-known content delivery and consumption systems. Server device 12 provides content to a plurality of client devices 16, 18, 20, and 22 via a communications network 14. Network 14 may be any mechanism for communicating between network devices. In one embodiment, the network comprises the Internet. In other embodiments, the network comprises a satellite TV network or a cable TV network including a telephone line back channel. Although only a few client devices are shown in FIG. 1, it is understood that the number of client devices coupled to the network may comprise millions of devices. Similarly, although only one server is shown in FIG. 1, it is understood that the number of server devices supplying content to the client devices may comprise hundreds or thousands of servers.

In this architecture, when the server sends valuable content to one or more client devices, the server attempts to protect the content on the client devices. In one embodiment, the content comprises any audio-visual content, such as a movie, a television program, music, or a radio program. In another embodiment, the content comprises web pages or a combination of web pages and audio-visual content. Typically, software operating on the client device may be employed to protect the content by regulating access to the content by the client device. For example, when the system is a cable or satellite TV service, the server broadcasts or multicasts encrypted content to the client devices. The client devices include software to decrypt the encrypted content for viewing by a user if the client devices are authorized to do so. The client device software records the content reception, content decryption, and viewing activity in a data structure called a billing log. The billing logs 17, 19, 21, and 23 may be periodically communicated back to the server via the network or via a back-channel communications method (such as a telephone line) (not shown in FIG. 1) using well-known methods.

The operator of the server may also attempt to protect access to the content by designing the client device software such that it is tamper resistant according to known methods. Despite this, it still may be possible for malicious users to circumvent the tamper-resistant software and modify the billing log so that the log shows little or no client device activity. For example, it may be possible for a hacker to change the actual viewing history recorded in the billing log so that the hacker is billed less money (or even no money) by the server operator. If the billing log is modified in this manner, the operator of the server will lose revenue.

One approach to deterring such activity would be to uniformly update the software on all client devices periodically. The new software may contain new cryptographic or tamper resistant techniques to thwart any would-be hackers. However, when the number of client devices is very large, this may become impractical due to the load on the communications network. Another approach would be to update only those client devices where it may be detected that the billing log has been tampered with. However, in some cases, such detection may be very difficult, if not impossible. Hence, a method of selectively updating only certain client devices regardless of detectability of hacking activity or the number of client devices would be useful to server operators.

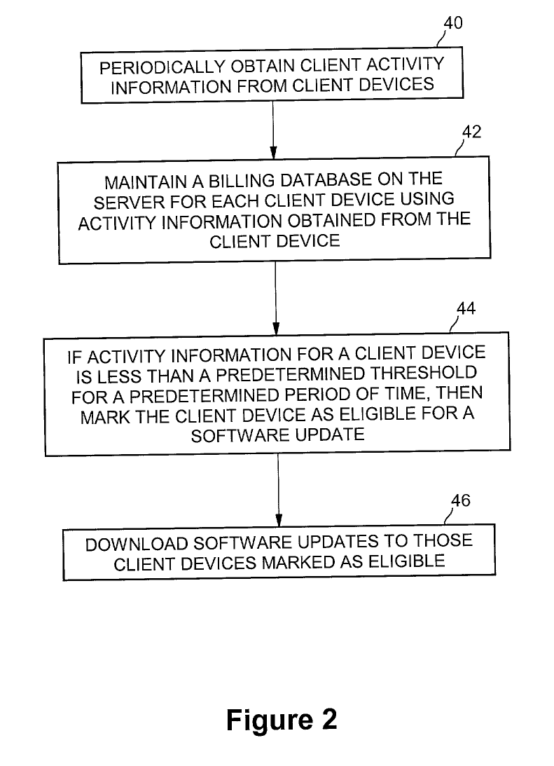

FIG. 2 is a flow diagram illustrating using billing log activity to determine software update frequency of client devices according to an embodiment of the present invention. Each client device includes software that records data describing at least some of the content received and/or consumed by the client device. In one embodiment, content consumption may include rendering the content in an audio and/or visual manner for perception by a user. At block 40, the server periodically obtains client activity data from the client devices. This client activity data may be used to generate billing information for the client devices. In one embodiment, the billing log of a client device may be communicated by software operating on the client device via a back channel from the client device to the server. In some architectures, this may be a telephone line. In other architectures, the back channel may comprise sending packets of information via the network. The billing log comprises client activity data. That is, the client activity data comprises content reception and/or content consumption activities of the client device.

At block 42, the server maintains a billing database or a portion of a billing database for each client device. The billing database stores client activity data obtained from the client device. Thus, the billing database may comprise the content reception and consumption activity of the client device for a selected period of time. At block 44, if the client activity data for a given client device indicates activity that is less than a predetermined threshold for a selected period of time, then the client device may be marked in the billing database as eligible to receive a software update. For example, the predetermined threshold may be set to two pay-per-view (PPV) movies in a one month period of time. If the customer receives and watches fewer than two movies during the month, it may be assumed for purposes of software update that the client device has been hacked, regardless of the actual status of the client device software. The predetermined threshold may be set to any suitable number and unit of content, depending on the specific characteristics of the system architecture. Additionally, the selected period of time may be set to any appropriate duration.

At block 46, the server downloads or otherwise distributes a software update to only those client devices marked as eligible to receive an update at block 44. In this way, reported client activity may be used to determine when new software updates to client devices may be performed. Hence, if tamper resistant software on a particular client device has somehow been hacked to defeat the billing reporting mechanism, the hack can now be defeated by downloading new software with new features that will defeat the successful hack against the old version of the software. The new features may include new cryptographic keys, new cryptographic techniques, new tamper resistant techniques, new configurations of the software, and so on. By targeting only those client devices that are not reporting much, if any, content reception and consumption activity, the overall time spent downloading new software to client devices may be reduced and the overall bandwidth required to distribute software updates may be reduced. Without making this determination, a server operator must choose between losing revenue and updating all client devices.

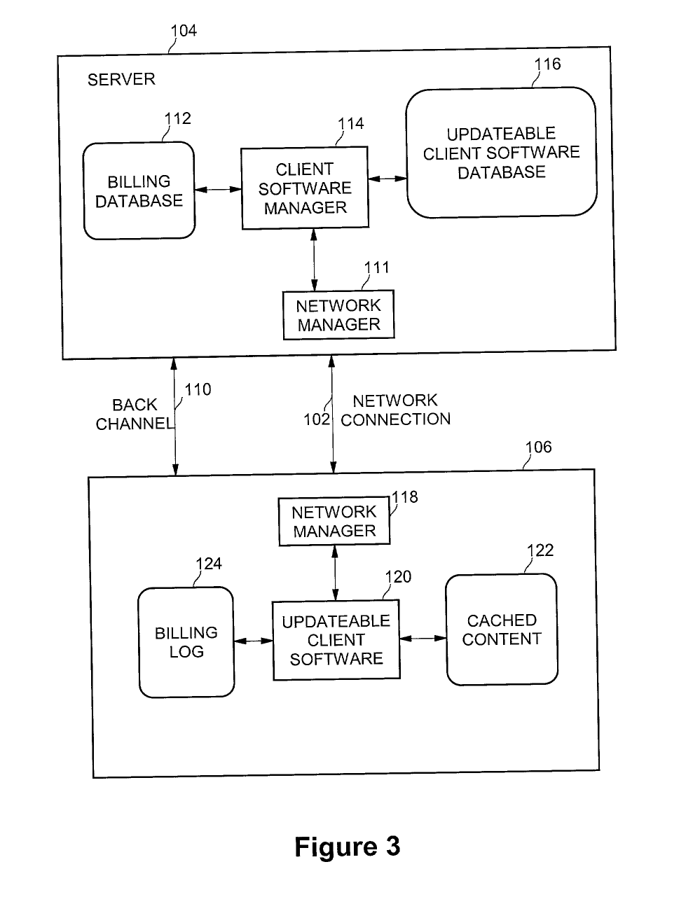

FIG. 3 is a diagram of an example system architecture using billing log activity to determine software update frequency according to an embodiment of the present invention. This architecture 100 is representative of a video on demand (VOD) service using a broadband network connection 102 to distribute multimedia content to users. In this system, the content may be distributed from server 104 to client device 106 and cached in a storage module within the client device. In one embodiment, the content may be a motion picture or a television program. The distributed content may be encrypted and the keys to decrypt the content on the client device may be acquired through back channel 110. In one embodiment, the back channel may be a telephone line. The back channel may, in some embodiments, also be used to communicate the billing log information to the server. In one embodiment, the keys need to decrypt cached content may be acquired prior to a viewing session of selected content.

Server 104 comprises network manager 111, billing database 112, client software manager 114, and client software database 116. Network manager 111 may be used to communicated with the client device. Billing database 112 stores client activity data for at least one client. There may be separate databases for each client devices, or a single database may be used to store information about all client devices. The billing database receives the billing log information received from the client devices. Client software manager 114 monitors the billing log activity for client devices, marks clients for delivery of updated client software if the client activity data indicates this is necessary, and manages the download process for updated client software. Client software database 116 stores new versions of updateable client software.

Client device 106 comprises network manager 118, updateable client software 120, cached content 122, and billing log 124. Network manager 118 communicates with server 104. Updateable client software 120 generates new billing entries in the billing log for client activity, secures the billing log, and coordinates the periodic transfer of the billing log to the server. Cached content 122 comprises a database storing content received from the server for subsequent viewing by the user. Billing log 124 stores the client activity data for the client device. The billing log 124 may be sent to the server 104 at least once during a billing cycle. The frequency of sending of the billing log may be adjustable (e.g., one week, two weeks, one month, and so on).

Although known tamper resistant technology may be used to protect the updateable client software and any cryptographic keys used, and it may be difficult to monitor the behavior of the client device by the user, the client device software may still be hacked to show little or no content reception and consumption activity.

With embodiments of the present invention, an update to the client device software may be forced whenever the activity reported in the billing log 124 is less than a predetermined amount within a predetermined period of time. A wide variety of changes to the updateable client software may be made and downloaded to the selected client devices. Changes may include changing the cryptographic keys used, changing the key hierarchy, using a different secret for generating and/or using keys, changing the way the software modules interact, changing the protocols used for receiving and decrypting content, moving functionality between selected components of the software, and so on. Since it may be expensive to download a software update to a client device over, for example, a 56K modem line, only updating those client devices likely to have been hacked may save network bandwidth. By using the billing log information on content transaction history, various heuristics may also be applied to the information to select client devices to get an update. For example, if specific errors occur in the billing log (such as invalid digital signatures), it may be assumed that the client software has been hacked. Other parameters may also be taken into account, such as when a user goes on vacation and doesn't consume content for an extended period of time.

This process may be performed due to three different circumstances. First, the forced update may be done proactively when the billing log information indicates that a customer is not buying enough content so as to appear as suspicious to the server operator. If the reported usage is low enough or nonexistent, it may be assumed the client device software has been hacked. Secondly, if an attack on the client device software generally becomes known, then the server operator may need to prioritize the list of all installed client devices in order to select those client devices to update before other client devices. That is, it may be beneficial to update those client devices reporting low content reception and consumption activity before updating those client devices reporting substantial activity. Thirdly, the forced updates may be initiated as part of a general security mechanism for the system architecture. By periodically changing the software on selected client devices, widespread hacking of the client devices may be deterred.

In the preceding description, various aspects of the present invention have been described. For purposes of explanation, specific numbers, systems and configurations were set forth in order to provide a thorough understanding of the present invention. However, it is apparent to one skilled in the art having the benefit of this disclosure that the present invention may be practiced without the specific details. In other instances, well-known features were omitted or simplified in order not to obscure the present invention.

Embodiments of the present invention may be implemented in hardware or software, or a combination of both. Some embodiments of the invention may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the invention is not limited in scope to any particular programming language. In any case, the language may be a compiled or interpreted language.

The programs may be stored on a storage media or device (e.g., floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

While this invention has been described with reference to illustrative embodiments, this description is not intended to be construed in a limiting sense. Various modifications of the illustrative embodiments, as well as other embodiments of the invention, which are apparent to persons skilled in the art to which the inventions pertains are deemed to lie within the spirit and scope of the invention.

What is claimed is:

1. A method of determining when to update software of a client device comprising:
receiving client activity data from the client device; and
updating software resident on the client device when the client activity data indicates activity less than a predetermined threshold for a selected period of time.

2. The method of claim 1, wherein the client activity data comprises information describing at least one of reception of content and consumption of content by the client device.

3. The method of claim 2, wherein the content comprises audio-visual content received over at least one of a broadcast network and a multicast network and content consumption comprises rendering the audio-visual content for perception by a user.

4. The method of claim 1, further comprising maintaining a billing database for the client device using the client activity data.

5. The method of claim 2, wherein the content is encrypted and the client activity data comprises information describing operations performed by the client device to decrypt the received content prior to consumption of the content by the client device.

6. The method of claim 1, wherein the software resident on the client device comprises tamper resistant software.

7. The method of claim 1, wherein the updated client device software comprises at least one of a new cryptographic key, a new cryptographic technique, a new tamper resistant technique, and a new software configuration.

8. An article comprising: a storage medium having a plurality of machine accessible instructions, wherein when the instructions are executed by a processor, the instructions provide for determining when to update software of a client device by receiving client activity data from the client device; and updating software resident on the client device when the client activity data indicates activity less than a predetermined threshold for a selected period of time.

9. The article of claim 8, wherein the client activity data comprises information describing at least one of reception of content and consumption of content by the client device.

10. The article of claim 9, wherein the content comprises audio-visual content received over at least one of a broadcast network and a multicast network and content consumption comprises rendering the audio-visual content for perception by a user.

11. The article of claim 8, further comprising instructions for maintaining a billing database for the client device using the client activity data.

12. The article of claim 9, wherein the content is encrypted and the client activity data comprises information describing operations performed by the client device to decrypt the received content prior to consumption of the content by the client device.

13. A method of determining when to update content reception and consumption software of client devices in a client/server system comprising:
receiving client activity data from a plurality of client devices, the client activity data comprising information describing at least one of reception of content and consumption of content by each client device;
maintaining a billing database for the client devices using the received client activity data;
marking a client device in the billing database as eligible for receiving updated content reception and consumption software when client activity data for the client device indicates activity less than a predetermined threshold for a selected period of time; and
downloading the updated software to the marked client device for subsequent use in receiving and consuming content.

14. The method of claim 13, wherein the content is encrypted and the client activity data comprises information describing operations performed by the content reception and consumption software of the client device to decrypt the received content prior to consumption of the content by the client device.

15. The method of claim 14, wherein the content reception and consumption software resident on the client device comprises tamper resistant software.

16. The method of claim 15, wherein the updated content reception and consumption software comprises at least one of a new cryptographic key, a new cryptographic technique, a new tamper resistant technique, and a new software configuration.

17. The method of claim 16, wherein the content comprises at least one of a motion picture and a television program.

18. An article comprising: a storage medium having a plurality of machine accessible instructions, wherein when the instructions are executed by a processor, the instructions provide for determining when to update content reception and consumption software of client devices in a client/server system by receiving client activity data from a plurality of client devices, the client activity data comprising information describing at least one of reception of content and consumption of content by each client device, maintaining a billing database for the client devices using the received client activity data, marking a client device in the billing database as eligible for receiving updated content reception and consumption software when client activity data for the client device indicates activity less than a predetermined threshold for a selected period of time, and downloading the updated software to the marked client device for subsequent use in receiving and consuming content.

19. The article of claim 18, wherein the content is encrypted and the client activity data comprises information describing operations performed by the content reception and consumption software of the client device to decrypt the received content prior to consumption of the content by the client device.

20. The article of claim 19, wherein the content comprises at least one of a motion picture and a television program.

21. A server in a content distribution system comprising:
a billing database to store client activity data received from a plurality of client devices, the client activity data comprising information describing at least one of reception of content and consumption of content by each client device;
a client software update database to store versions of updateable content reception and consumption software; and
a client software manager configured to receive client activity data from the client devices, to update the billing database using the received client activity data, to mark a client device in the billing database as eligible for receiving updated content reception and consumption software when client activity data for the client device indicates activity less than a predetermined threshold for a selected period of time, and to download a version of the updateable content reception and consumption software to each marked client device for subsequent use in receiving and consuming content.

22. The system of claim 21, wherein the updateable content reception and consumption software comprises tamper resistant software.

23. The system of claim 21, wherein the updated content reception and consumption software comprises at least one of a new cryptographic key, a new cryptographic technique, a new tamper resistant technique, and a new software configuration.
